(19) United States
(12) Patent Application Publication
(10) Pub. No.: US 2008/0236670 A1
(43) Pub. Date: Oct. 2, 2008

(54) APPARATUS AND METHOD FOR ASSEMBLING A NON-REFILLABLE VALVE UNIT

(76) Inventor: Park Jin Hyoung, Incheon (KR)

Correspondence Address: DITTHAVONG MORI & STEINER, P.C., 918 Prince Street, Alexandria, VA, 22314, US

(21) Appl. No.: 11/695,337

(22) Filed: Apr. 2, 2007

(51) Int. Cl. F16K 43/00

(52) U.S. Cl. 137/15.18

(57) ABSTRACT

An approach is provided for preventing refilling of a gas cylinder. A non-refillable apparatus includes a valve housing having a seat formed to receive a valve assembly in which a non-refillable valve member is assembled. The non-refillable valve assembly configured to prevent refill attempt by a pin action to pass a ball through a shelf to a position where the ball can block an incoming flow occurred at opening created within the valve assembly, wherein the shelf is disposed within the valve assembly.

### BACKGROUND INFORMATION

Pressure cylinders with various gases or fluids, e.g., propane, butane and MAPP (liquefied petroleum gas mixed with methylacetylene-propadiene), are under control when charged at a charging station. After use, non-refillable valve units are to be returned for refill or destruction upon proper inspection. Unfortunately, extensive reuse (i.e., refilling) is unsafe and can result in catastrophic events, such as explosions.

Because of the safety concerns, various techniques have been developed to prevent refilling of a compressed gas in a cylinder. For example, a conventional non-refillable valve and its housing are formed to receive the valve. The valve and the housing are engaged securely using a thread prepared inside of the wall of valve housing. Consequently, assembly line processes are required to adopt assembly of a non-refillable valve, whereby the non-refillable valve is screwed down into valve housing. In addition, a Teflon® gasket of the valve core member is stuffed into a taper part of the valve housing. Unfortunately, these conventional techniques suffer from a number of drawbacks. First, installing the valve into the valve housing at a proper position is difficult. Also, unmatched screws generate chips that cause leakage. Because of improper insertion of the valve, the taper part of valve housing and the Teflon(M gasket of valve core cannot be sealed properly. Moreover, the chips originating from the drain into a gasket (e.g., Teflon(g) gasket) prevent proper sealing.

U.S. Pat. No. 6,595,230 to Raboin, as shown in FIG. 9, provides a non-refillable valve in a compressed gas cylinder in which a detent formed in the valve housing extends into the valve chamber. A check ball is placed into the valve chamber at the proximal end of the valve member. A valve core is screwed into a threaded portion of the valve housing to complete the assembly of the non-refillable valve. One key drawback of the Raboin system is that the valve core and the valve housing are engaged using a thread. Since the taper part and the detent portion locate under the thread, the clogging and leaking effects cannot be avoided due to chips generated when threadly engaging the valve core into the housing. Moreover, having considered automatic assembly line, the assembling machines are not capable of detecting every cases of faulty position of the valve core when assembling into valve housing. Another drawback of the Raboin system is that the detent for supporting the check ball is formed at each inside of the valve housing protruding facing against each other that makes narrow passageway of flow thereby can cause clogging when charging or discharging the gas. Further, due to the detent formed at the valve housing, a complex casting arrangement is required for making the valve housing that may result in high manufacturing costs. This design extends to the accurate shape of the detent in order to limiting the clogging effect; consequently, mass assembling with flexibility is greatly diminished.

Therefore, there is a need for providing a non-refillable valve that provides ease of assembly, reduces the rate of manufacturing faults, while cost-effectively deterring refilling of cylinders.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram showing a sectional front view of a non-refillable valve housing formed within a cylinder according with an exemplary embodiment;

FIG. 2A is a diagram of a non-refillable valve assembly which is coupled with the valve housing of FIG. 1, according to an exemplary embodiment;

FIG. 2B is a diagram showing a top view of the non-refillable valve assembly, according to an exemplary embodiment;

FIGS. 3A and 3B are diagrams of a check ball and a shelf having a ball seat through which the ball can pass through the shelf, according to an exemplary embodiment;

FIG. 4 is a cross sectional view of the non-refillable valve assembly of FIG. 2A coupled into the valve housing of the FIG. 1, according to an exemplary embodiment;

FIGS. 5A-5D are diagrams showing assembling process of the non-refillable valve assembly in which non-refillable valve member is disposed within the assembly, according to an exemplary embodiment;

FIG. 6A is a diagram showing an exemplary joining method by which the non-refillable valve assembly of FIG. 2A and the valve housing of FIG. 1 can be joined by using an instant mechanical force applying to a spot formed when coupling, according to an exemplary embodiment;

FIG. 6B is a diagram showing another exemplary joining method by which a non-refillable valve assembly of FIG. 2A and the valve housing of FIG. 1 can be joined by using a thread, according to an exemplary embodiment;

FIGS. 7A-7E are diagrams showing a gas flow associated with different positions of a check ball by a pin action when charging, depleting and blocking incoming gas flow when refill attempt, according to an exemplary embodiment;

FIG. 8 is a flow chart of process for assembling non-refillable valve assembly into a valve housing, according to an exemplary embodiment; and

FIG. 9 is a diagram showing a conventional method of assembling a non-refillable valve into a cylinder.

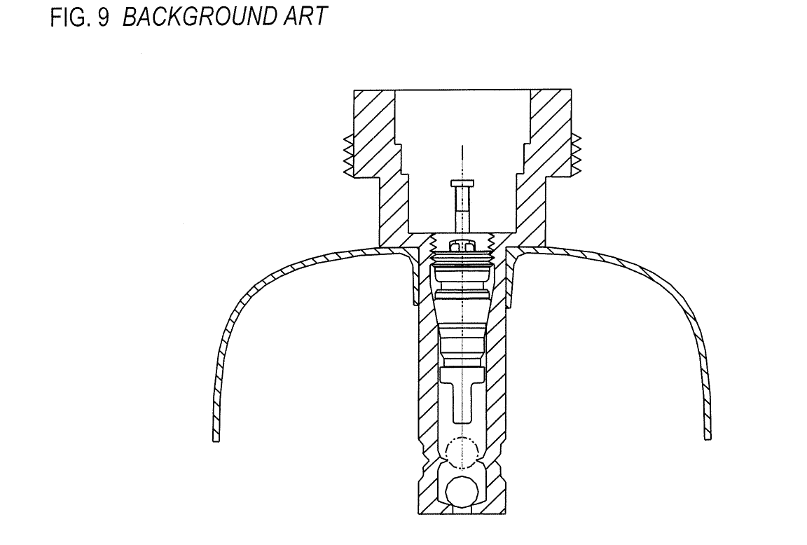

### DETAILED DESCRIPTION

An apparatus, device, and method for assembling a non-refillable valve member into a valve assembly and for engaging the assembled valve assembly into a valve housing of a container are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

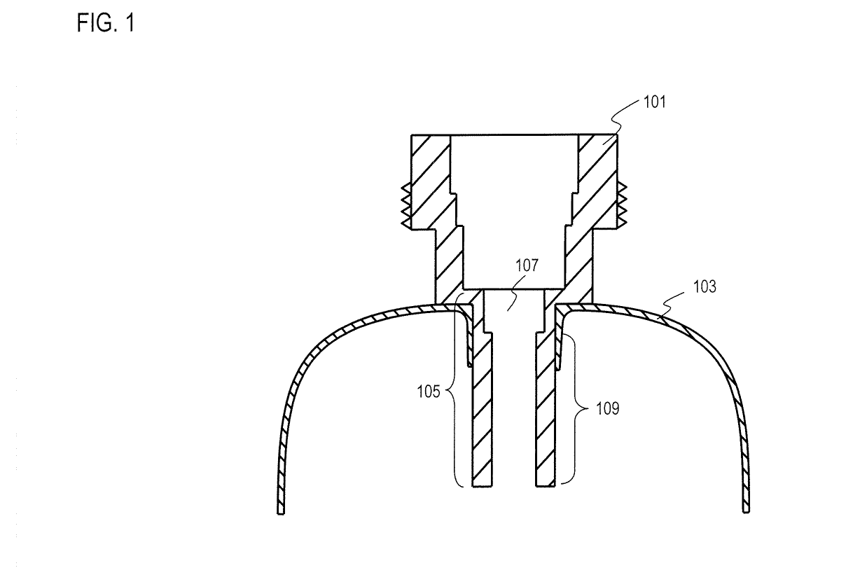

FIG. 1 is a diagram showing a sectional front view of a non-refillable valve assembly formed into a container (e.g., cylinder) according with an exemplary embodiment. In an example, a cylinder 103 includes a valve housing 105 configured to receive a non-refillable valve assembly. The valve housing 105 has an opening 107 and a cylindrical tube 109 being shaped in-line that are configured to receive the valve assembly as well as for facilitating a gas flow when charging and depleting. In an exemplary embodiment, the valve housing can be made of one of brass, cast iron, carbon steel, stainless steel, or synthetic material.

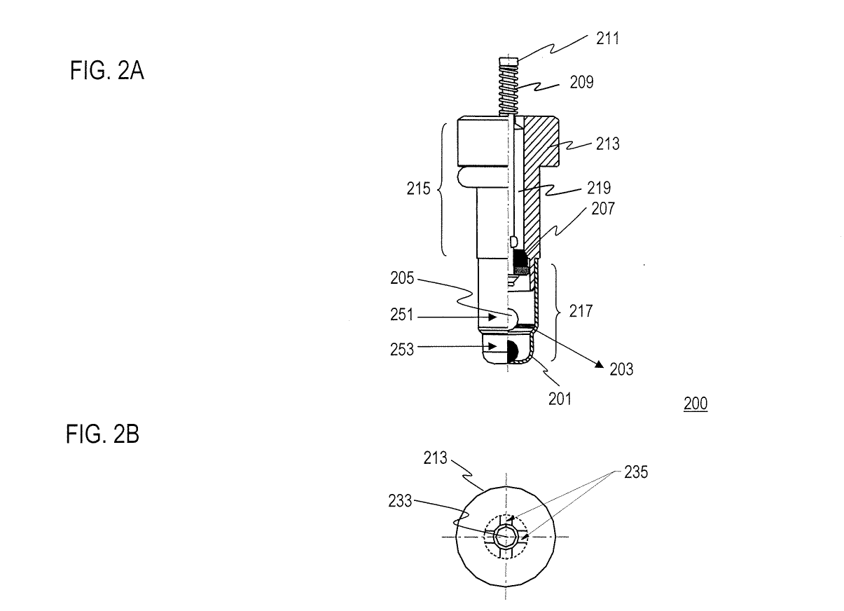

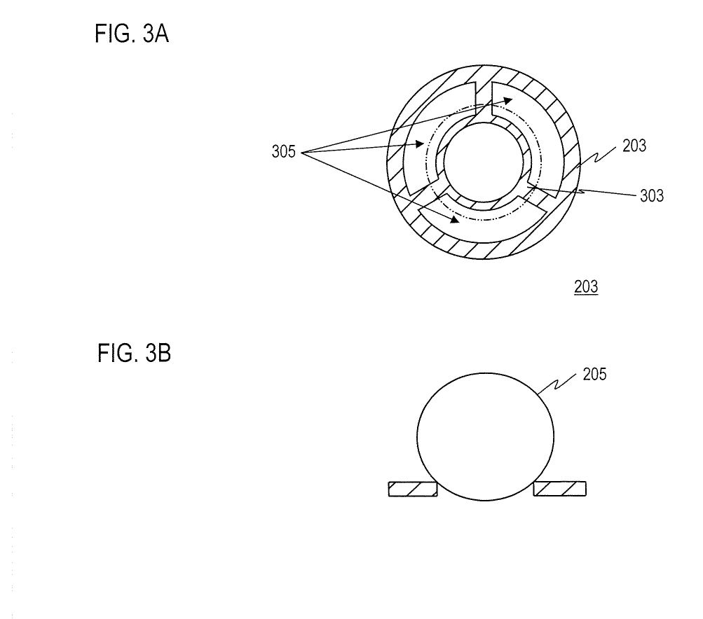

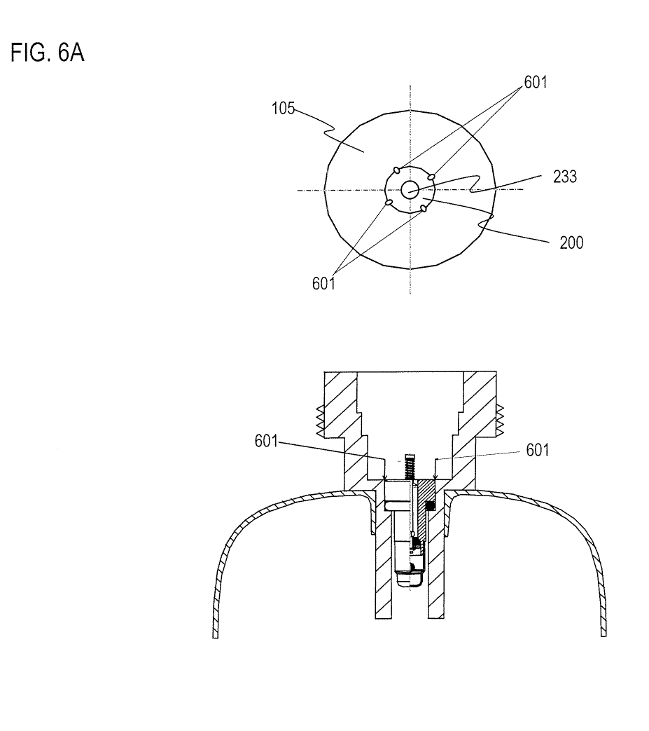

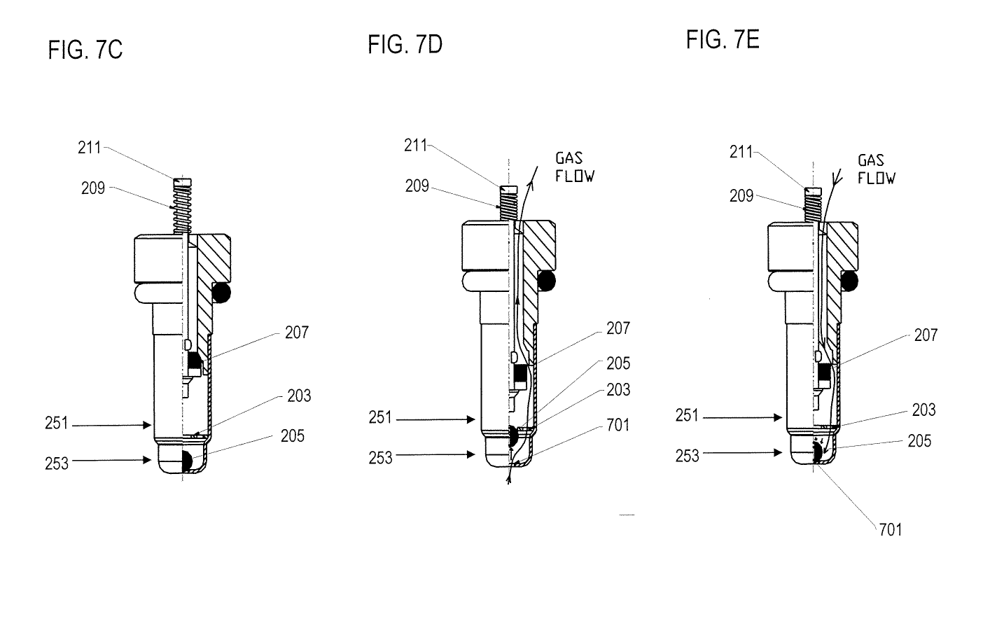

FIG. 2A is a diagram of a non-refillable valve assembly which is coupled with the valve housing of FIG. 1, according to an exemplary embodiment. The non refillable valve assembly 200 includes a first part 215 and a second part 217, wherein the first part comprises a rubber gasket 207, a spring 209 and a valve pin 211. The second part comprises a shelf 203 and a check ball 205. By way of example, the first part and second part of the valve assembly are engaged, as shown in FIGS. 5A-SD. Locations of the check ball can be defined as a first location 251 and second location 253 by moving of the check ball 205 through the shelf 203 associated with the pin 211 actions in combination of the spring 209 effect. In an exemplary embodiment, the body of valve core assembly 200 can be made one of brass, cast iron, carbon steel, stainless steel, or synthetic material. The spring 209, which is disposed on the outside of the valve pin 211 of upper portion of the valve core member 200. The spring 209 can resiliently push the rubber gasket 207 downward thereby air gas can flow into or can out from the first part 215 of the valve assembly 200. In an exemplary embodiment, the rubber gasket can be made of a rubber (e.g., natural rubber, hydrin rubber, or neoprene, etc.) can be disposed inside being covered by a gasket cup. Any biasing mechanisms other than the spring 209 can be applied. It is noted that the spring 209 may be any elastic material that works to regain its original shape after being compressed. The illustrations of gas flows when charging and discharging the gas associated with the valve pin 211 actions are explained in detail in FIG. 7A-7E.

FIG. 2B is a diagram showing a top view of the non-refillable valve assembly 200, according to an exemplary embodiment. As shown in the FIG. 2, according to an exemplary embodiment, the top portion includes a head 213 having a circle 233 in the center through which the valve pin 211 can be positioned. A plurality of slits 235 that are formed around the circle 233 to facilitate incoming and outgoing gas flows.

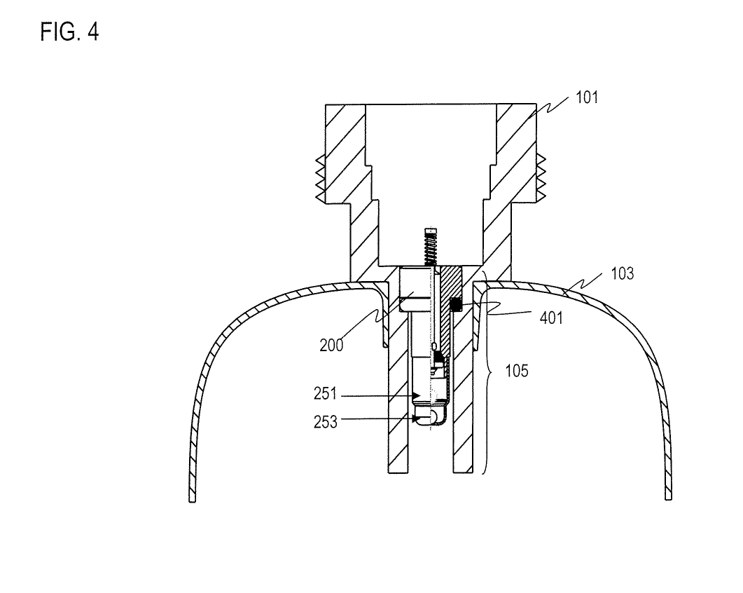

FIGS. 3A and 3B are diagrams of a check ball and a shelf having a ball seat through which the ball can pass through the shelf, according to an exemplary embodiment. As shown in FIG. 3A, in an embodiment, a shelf 203 has a seat 303 on which the check ball is positioned. The shelf 203 also has plurality of openings 305 formed around the seat 303 for facilitating ingress and egress of a gas flow. The material of the check ball requires both hardness and resilience characteristics. Aided by this quality, check ball 205 can pass through the check ball seat 303 of the shelf 203 by a pin 211 action that causes to move the ball 205 from first position 251 to second position 253 where the ball is positioned to effectively seal off the opening at the valve assembly 200 and to block an incoming air flow into the cylinder 103 through the valve assembly 200 during a refill attempt. In an exemplary embodiment, the check ball can be made of rubber such as natural rubber, hydrin rubber or neoprene.

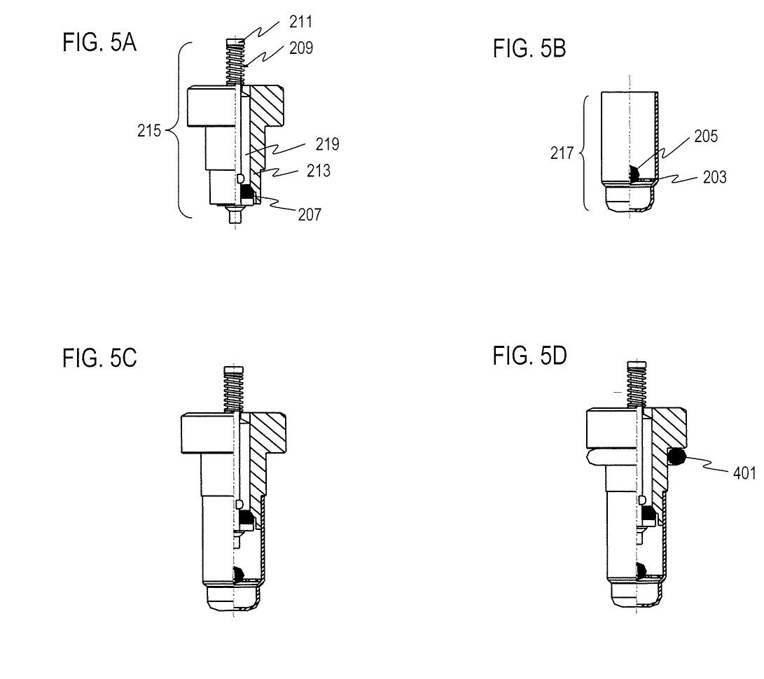

FIG. 4 is a cross sectional view of the non-refillable valve assembly of FIG. 2A coupled into the valve housing of the FIG. 1, according to an exemplary embodiment. In order for sealing effect between valve assembly 200 and the valve housing 105, an O-ring 401 is disposed at the valve seat where the non-refillable valve assembly 200 can be seated. Under this design, all incoming and outgoing gas flow is passed through the valve assembly 200. In addition, the valve assembly is configured to prevent flow when a refill is attempted. Therefore, an attempted incoming flow from a refill action can be blocked at the passageway formed within the valve assembly according to the movements of the check ball for sealing off the passageway.

FIGS. 5A-5D are diagrams showing assembling process of the non-refillable valve assembly in which non-refillable valve member is disposed within the assembly, according to an exemplary embodiment. In FIG. 5A, the first part 215 of the valve assembly 200 includes a valve pin 211 which extends through the tube 219 formed within the first part 215 of assembly 200. The spring 209 is positioned over at one end of the valve pin 211 and the gasket 207 is resiliently attached to the other end of the valve pin 211 in order to seal off an opening formed at the tube 219. As shown in FIG. 5B, the check ball 205 is positioned on the shelf 203. By way of example, the check ball 205 and the shelf 203 are disposed within the second part 217 of the valve assembly 200. As shown in FIG. SC, the first part 215 and the second part 217 are engaged to become an engaged non-refillable valve assembly 200. As pointed out earlier, an O-ring 401 is positioned at the valve seat for sealing off the opening when engaging the assembled non-refillable valve assembly 200 into valve housing 105.

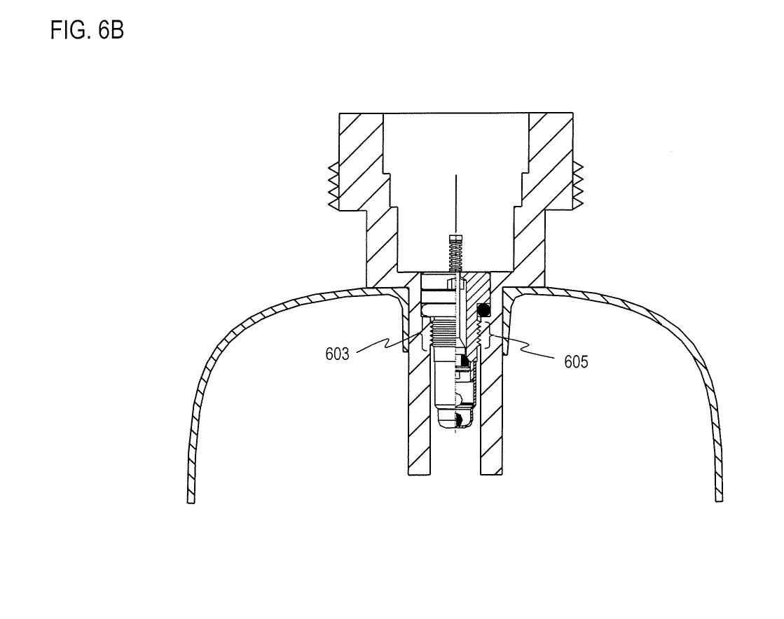

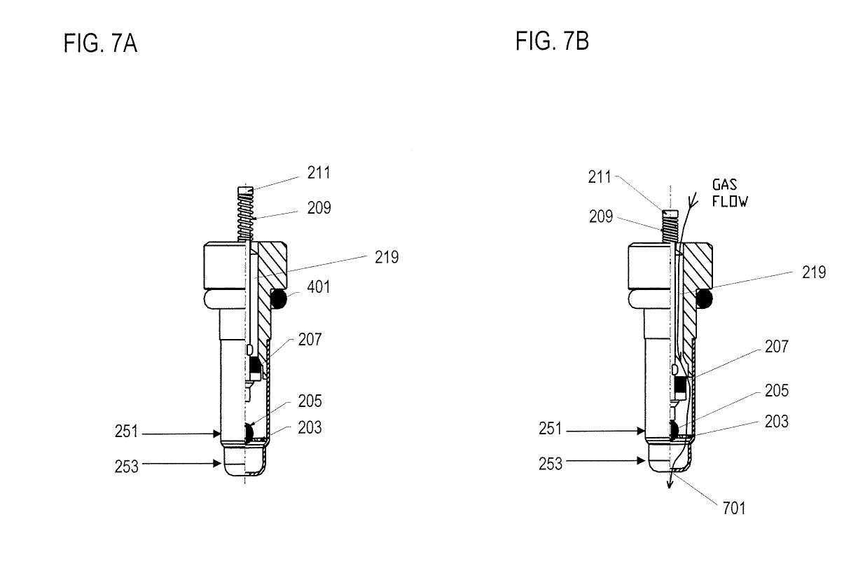

FIG. 6A is a diagram showing an exemplary joining means by which the non-refillable valve core assembly of FIG. 2A and the valve housing of FIG. 1 can be engaged by using an instant mechanical force applying to a spot formed when coupling, according to an exemplary embodiment. By way of example, non-refillable valve assembly is fixedly engaged into the housing using a mechanical welding method by impacting a mechanical force to a rim made at periphery portion between the valve assembly and the housing, wherein the rim is formed when the valve assembly is coupled to the valve housing. In this example, the non-refillable valve assembly 200 is seated in the valve housing 105 that is formed to receive the valve assembly 200. As shown in the FIG. 6A, according to a top view, the valve assembly 200 is covered by the inner periphery of valve housing. In order to fixedly engaging the valve core assembly 200 with the valve housing 105, an instant mechanical force is applied to the rim between materials. The engaging is made by the formation of a melted spot attributed by the applied mechanical force between the materials. The spot size 601 of the impact can between about 2 mm×2 mm to about 2 mm×3 mm, though these sizes can be varied according to the desirability of engaging degree that is proportional to the amount of pressure of gas charged associated with characteristics of material of the valve assembly 200 and valve housing 105.

FIG. 6B is a diagram showing another exemplary joining means by which a non-refillable core assembly of FIG. 2A and the valve housing of FIG. 1 can be joined utilizing a thread, according to an exemplary embodiment. In FIG. 6B, a male thread 603 is formed on valve assembly but the thread locates under the O-ring and female thread 605 corresponding to the male thread 603 are formed on inner wall of the valve housing 105 in order to engage the valve assembly 200 and the valve housing 105 together. In this example, using threads to assemble the valve housing 105 and valve assembly 200 may lead to chips due to cross threading, however since the threads are positioned lower than the O-ring 401, chips that are created during a engaging process fall downward to the cylinder 103. Namely, the sealing between the assembly and the housing of the cylinder can be achieved perfectly regardless of chips. Unlike the conventional method, which possess a chip generated problem addressed before, this exemplary embodiment clearly overcomes a potential leakage problem caused by chips as the generated chips cannot fall on a sealing portion, for example, a gasket. This is because the gasket 207 is located within the valve assembly 200. In addition, according to an exemplary embodiment, the sealing portion where the O-ring seats are located above the threads, thereby the sealing is not affected by the chips.

The valve assembly can be joined with the valve housing using various methods of welding processes, such as arc welding, oxyfuel gas welding, resistance welding and solid state welding. Moreover, in some cases, customized engaging process can be performed to match different sizes of valve assemblies and the corresponding shapes of receiving portion of the valve housing—this approach is particularly suitable for customized process.

FIGS. 7A-7E are diagrams showing a gas flow associated with different positions of a check ball by a pin action when charging, depleting and blocking incoming gas flow when refill attempt, according to an exemplary embodiment. FIG. 7A shows a non-refillable valve assembly in which a check ball 205 is positioned on the shelf 203 (first position 251 of FIG. 2A). The gasket 207 is configured to resiliently seal off the tube 219 by the spring 209 disposed outside of the valve pin 211. In this state, a gas is ready to be charged into the cylinder 103 through the non-refillable valve assembly 200. In FIG. 7B, when charging, the pin 211 is pushed downward to open the gasket 207. The charging gas flow is coming into via plurality of slits 235 of the valve assembly 200 and the gas continue to pass through the tube 219 to reach the gasket. The already opened gasket allows the gas flow to continue to reach to the shelf 203 on which the check ball is positioned. Since the shelf 203 has multiple openings 305 (See FIG. 3A), the gas can be charged into the cylinder via the openings 305. While the charging, the check ball 205 maintains its position being on the shelf 203 (first position 251). After completing the charging, the pin is pushed down by an inspector until the pin can move the ball to change the ball position from the first position 251 to the second position 253. Since the ball 205 has elastic characteristics the ball 205 can pass through the shelf 203. According to elastic characteristic of the spring, the pin 211 can press to move the ball 205 and the pin 211 can be returned to an original position. From the original position of the pin, in FIG. 7C, the gasket 207 also can be a position to seal off the opening. When a charged gas is used, according to FIG. 7D, the pin is pushed down to allow the charged gas coming out from the cylinder 103. The passageway of the gas is in the opposite direction of the flow when charging the gas. In this case, the outgoing gas pushes the ball upward, thereby an opening can be made at the passageway 701 formed at the bottom of the second assembly 217 through which the gas can pass via the plurality of openings 305 within the shelf 203. After depleting the charged gas, in FIG. 7E, when refilling is attempted, the incoming gas can effectively move the ball to seal off the opening at the ball seat 701. Consequently, the incoming gas cannot pass through the valve assembly 200 that prevent the refilling gas into the cylinder.

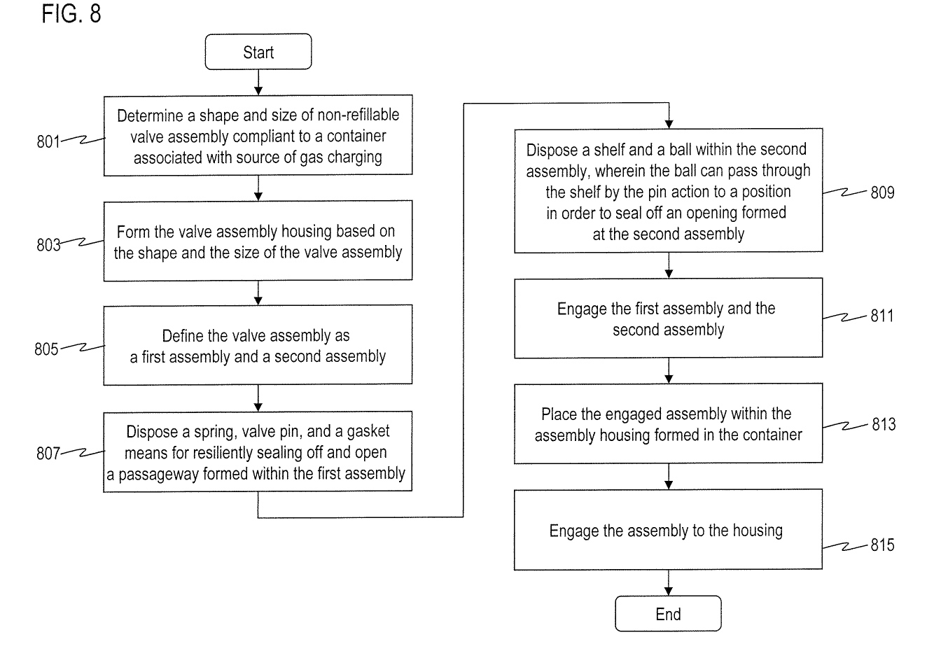

FIG. 8 is a flowchart of assembly of non-refillable valve, in accordance with an embodiment of the present invention. In step 801, a manufacturer (assembler) can determine a shape and size of non-refillable valve assembly 200 and the valve housing 105 conforming to characteristics of charging gas and a container (cylinder) 103. When the size and shapes are determined, per step 803, the manufacturer can fix the valve housing 105 of cylinder (container) for receiving a non-refillable valve assembly 200. The valve assembly comprises two parts, per step 805: first assembly 215 and second assembly 217. By way of example, per step 807, the first assembly 215 comprises a spring 209 disposed outside of one end of the valve pin 211 and a gasket 207 coupled to the other end of the valve pin 211 means for resiliently sealing off a passageway formed within the first assembly 215. In step 809, a ball 205 and a shelf 203 are disposed within the second assembly 217, wherein the shelf 203 has a ball seat 303 and plurality of openings 305 formed around the ball seat 303. The ball 205 can pass through the shelf 203 by the pin action to a second position 253. At this position, the ball 205 can block incoming gas flow through the second valve assembly 217 when refill is attempted. In step 811, the first assembly 215 and the second assembly 217 are engaged. For the step 811, an O-ring can be used for the sealing effect when engaging. According to step 813, an assembler can place the engaged non-refillable valve assembly 200 within the assembly housing 105. The assembly housing 105 can be designed according to the container shape associated with the shape of the valve assembly 200 after determining the characteristics of charging gas. In step 815, the valve assembly 200 is fixedly engaged with the assembly housing 105 by means of engaging methods.

Therefore, according to an exemplary embodiment, a non-refillable valve assembly and a housing are provided. The valve housing having a seat formed to receive a valve assembly in which a non-refillable valve member is assembled. The valve housing being attached to a cylinder, wherein a source is charged or depleted through a passageway made within the assembly, wherein the valve assembly configured to prevent refill attempt by a pin action to move a ball through a shelf to a position where the ball can block an incoming flow occurred at the passageway created within the valve assembly, wherein the ball action associated with the shelf is occurred within the valve assembly.

In one aspect of the exemplary embodiment, a non-refillable device is provided in which a valve housing formed at a container having a seat and an opening. The device includes a non-refillable valve assembly having a first valve assembly and a second valve assembly, wherein the first assembly and the second assembly are engaged and the engaged assembly is coupled into the seat, wherein a gas flow can into and can out of the container via the engaged assembly. The device further includes a gasket is disposed means for resiliently seal off an passageway formed at the first assembly, wherein a pin, a spring and the gasket are assembled within the first assembly; and a shelf disposed within the second assembly configured to define the ball position, wherein the ball locates on the shelf when charging a gas, wherein the ball is passed through the shelf associated with the pin action to a position so as to seal off an opening formed at the second assembly, wherein an unauthorized refilling gas flow can be blocked.

In another aspect of the exemplary embodiment, a method for making a non-refillable valve and assembling the valve into a container. The method includes fixing a valve housing having a seat for receiving a non-refillable valve assembly. The method includes assembling a first part of the assembly, wherein the first part includes a spring disposed outside of a valve pin and a gasket coupled to the valve pin means for resiliently sealing a passageway formed within the first assembly. The method further includes disposing a ball and a shelf within a second part of the assembly, wherein the shelf having a ball seat and plurality of openings formed around the ball seat, wherein the ball can be passed through the shelf associated with an action by the valve pin. The method includes engaging the first part and the second part to form a non-refillable valve assembly and placing the engaged assembly and coupling into the assembly housing formed in the cylinder vessel. The method includes engaging the assembly with the housing by various engaging methods.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. An apparatus for preventing a refill action, comprising:
a valve housing having a seat formed to receive a valve assembly in which a non-refillable valve member is assembled and the valve housing is attached to a cylinder, wherein a source is charged or depleted through a passageway within the valve assembly,
wherein the valve assembly is configured to prevent refill attempt by a pin action to move a ball through a shelf to a position where the ball can block an incoming flow via an opening created within the valve assembly.

2. An apparatus according to claim 1, wherein the valve assembly includes a first part engaged in a second part, and
the first part of the valve assembly includes a head, the pin, a spring and a gasket,
the second part of the valve assembly including the shelf and the ball.

3. An apparatus according to claim 1 further comprising: means for engaging the valve assembly with the valve housing.

4. An apparatus according to claim 2, wherein the head includes plurality of slits configured to facilitate ingress or egress of the source flow through the valve assembly.

5. An apparatus according to claim 1, wherein the shelf has a plurality of openings formed around the ball seat so as to facilitate the source flow.

6. An apparatus according to claim 1, wherein the seat includes an O shaped ring positioned so as to seal off gaps formed when receiving the valve assembly.

7. An apparatus according to claim 1, wherein the diameter of the ball ranges from about 1.9 mm to about 2.1 mm.

8. A non-refillable device, comprising:
a valve housing formed at a container having a seat and an opening;
a non-refillable valve assembly having a first valve assembly and a second valve assembly, wherein the first assembly and the second assembly are engaged and the engaged assembly is coupled into the seat, wherein a gas can flow into and out of the container via the engaged assembly;
a gasket for resiliently sealing off a passageway formed at the first assembly, wherein a pin and a spring are assembled within the first assembly; and
a shelf disposed within the second assembly configured to define the ball position, wherein the ball is disposed on the shelf when charging a gas and is passed through the shelf associated with the pin action to a position so as to seal off an opening formed at the second assembly.

9. A non-refillable device according to claim 8 further comprising: means for engaging the valve assembly with the valve housing.

10. A non-refillable device according to claim 8, wherein the first assembly includes a head having plurality of slits configured to facilitate ingress or egress of gas flow through the valve assembly.

11. A non-refillable device according to claim 8, wherein the shelf has a plurality of openings formed around a ball seat to facilitate flow.

12. An apparatus according to claim 8, wherein the seat includes an O shaped ring positioned so as to seal off gaps formed when receiving the non-refillable valve assembly into the seat.

13. An apparatus according to claim 8, wherein the diameter of the ball ranges from about 1.9 mm to about 2.1 mm.

14. A method for assembling a non-refillable valve assembly, the method comprising:
forming a valve housing having a seat for receiving a non-refillable valve assembly;
assembling a first part of the assembly, wherein the first part includes a spring disposed outside of a valve pin and a gasket coupled to the valve pin means for resiliently sealing a passageway formed within the first assembly;
disposing a ball and a shelf within a second part of the assembly, wherein the shelf having a ball seat and plurality of openings formed around the ball seat, wherein the ball can be passed through the shelf associated with an action by the valve pin;
engaging the first part and the second part to form the non-refillable valve assembly;
placing the engaged non-refillable valve assembly and coupling the engaged valve assembly into the assembly housing formed within a cylinder; and
fixedly engaging the assembly with the housing.

15. A method according to claim 14, wherein the seat includes an O shaped ring positioned at the seat so as to seal off gaps formed when receiving the non-refillable valve assembly into the seat.

16. A method according to claim 14, wherein the diameter of the ball ranges from about 1.9 mm to about 2.1 mm.
